(19) United States
(12) Patent Application Publication
(10) Pub. No.: US 2024/0318337 A1
(43) Pub. Date: Sep. 26, 2024

(54) METHOD OF OPERATING AN ELECTROLYZER AND ELECTROLYSIS ARRANGEMENT

(71) Applicant: HITACHI ZOSEN INOVA AG, Zürich (CH)

(72) Inventors: Michael DOLL, Stuttgart (DE); Alfred HERING, Stuttgart (DE); Christian HAEGELE, Stuttgart (DE)

(21) Appl. No.: 18/275,143

(22) PCT Filed: Feb. 2, 2022
(86) PCT No.: PCT/EP2022/052426

§ 371 Date: Jul. 31, 2023

(30) Foreign Application Priority Data
Feb. 2, 2021 (EP) 21154837.5

(51) Int. Cl. C25B 15/027

(52) U.S. Cl. CPC C25B 15/027

(57) ABSTRACT

A method of operating an electrolyzer including one or more cells stacked within a cell stack, whereby during operation of the electrolyzer, the temperature in one or more locations in the cell stack is indirectly or directly measured, in particular directly by one or more sensors having their sensitive element inserted inside the cell stack.

The invention relates to a method of operating an electrolyzer, comprising one or more cells stacked within a cell stack, and to such kind of electrolyzers/electrolysis arrangements.

In particular, the invention relates in one aspect to such electrolyzers being configured to perform electrolysis of water to produce hydrogen (and oxygen). Further, in a further aspect, the invention relates in particular to those electrolyzers performing alkali electrolysis.

Such electrolysis of the cell stack type are well known and f.i. disclosed in DE 10 2014 010 813 A1 or EP 0 212 240 B1.

During operation of electrolysis performing alkali electrolysis, the electrolyte, f.i. KOHaq, flows through the manifold or manifolds created by holes and openings in the cell frames. From time to time, the cell voltage of the single cells are measured, in order to detect a drop in the cell voltage which can be a first indication that the electrolyzer is no more running at its maximum performance. On the other hand side, it is known to check, from time to time, the concentration of the alkali lye which is subject to change due to water consumption on the one hand side and otherwise losses of the electrolyte on the other hand side.

Not withstanding such measures, although the electrolysis technique used in such electrolysis systems is, regarding the working principle, known since very long time, there are still developments in order to improve efficiency and performance of physically implemented electrolyzer systems. Thereby, sometimes it turns out that electrolyzer systems having quite good performance initially, drop in performance over time and have durability or lifetime lower than expected.

It is, therefore, an object of the invention to improve durability and/or long-time performance of such electrolyzer systems.

This object is, in terms of a method, solved by a further development which is essentially characterized in that during operation of the electrolyzer, the temperature in one or more locations in the cell stack is indirectly or directly measured, in particular directly by one or more sensors having their sensitive element inserted inside the cell stack.

This further development allows for a high durability of the working system and also an increase of the durability of the system, since detrimental effects to the process can be timely detected and can be counteracted in closer accuracy to the working status of the system. For instance, when a temperature condition is kept outside ideal working conditions for too long time, this is found as to have relevant impact on the long-time performance of the electrolyzer systems. Moreover, it has been found out that deviations from reasonable optimized working conditions can be anticipatingly recognized by said measuring and preferably also monitoring of measured (direct or indirectly) temperature, in particular changes in temperature over time and/or in comparison to pre-defined references, in particular also deviations in a temperature profile (specially resolved temperature distribution) over time and/or as compared to a pre-defined reference profile. Moreover, reactions to be taken upon detecting changes going beyond pre-defined thresholds, like maintenance, operation stop, or other measures can be provided with better accuracy, and in particular an actualized maintenance scheduling can be organized.

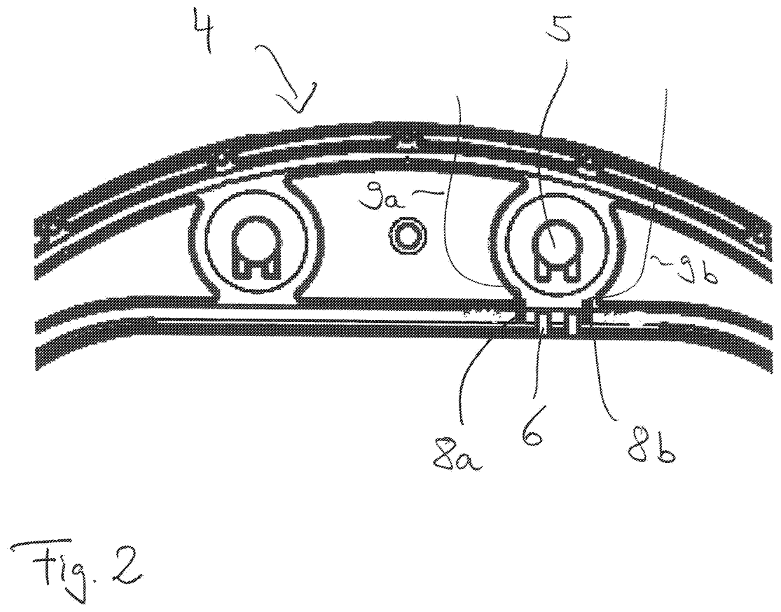

In a preferred embodiment, a sensitive element is inserted in a cell frame, in particular in close proximity to the border to the interior of the frame and/or to a channel connecting said interior to an axially extending collecting channel in the frame. Thereby, quite meaningful temperature values can be measured from the inside of the stack and still protection of the sensitive elements from chemical attacks is provided. The positioning of the sensitive element is preferred to be on the side where the electrolyte exits the interior of the frame (active zone). Thereby, temperature information is gained even in those zones being expected to have the highest risk of overheating. Further, regarding the positioning, it is preferred that the distance of the sensitive element from the interior of the cell frame is lower than 80%, preferably lower than 60%, in particular lower than 40% of its distance from the outer side of the cell frame. Further, it is preferred that the circumferential distance of the sensitive element from the electrolyte exit is lower than 40°, preferably lower than 30°, in particular lower than 20°. As stated above and is shown below in FIG. 2 as an example, the sensitive element embedded in cell frame material is protected from chemical attacks by the above proximity without direct contact with fluids flowing through said channels (no fluid communication of the sensitive element with said channels).

In a further preferred embodiment, the measuring is based on resistance temperature devices (RTD). However, in other embodiments, it is also envisaged to make use of thermo couples. Regarding the RTD, resistors on platin basis are preferred and/or resistors having a resistance at room temperature of 80 Ohm or even higher. For instance, PT100, more preferably PT1000 elements can be used. Industrial RTD-elements respectively sensors are further preferred.

In some embodiments, a 2-wire arrangement for connection to the RTD is considered sufficient, since a surveillance can reasonably based more on temperature gradients than on absolute values of the temperature. However, for increased accuracy, 3-wire arrangements or more preferably 4-wire arrangements are envisaged.

The wiring can be guided outside the outer shell of the cell frame. It can be guided from the location of the positioned electrolyzer to some control device arranged close to or also separately from the electrolyzer. A transducer can be provided at the side of the control, or also at the side of the electrolyzer. In any case, it is preferred that any wiring from the electrolyzer to the control is protected, f.i. on NSGAFOU level, and that also the connections are configured to not detrimentally affect the security level regarding EX-areas for the positioning of the electrolzyer.

In a possible embodiment, only one sensor is provided for the overall stack, this for every N-cells, and being the total number of cells in the staple. For N, it is preferred to have at least 40, more preferred at least 70, in particular at least 100 cells. It is, however, also envisaged to have even more cells, that is 120 cells or more, 130 cells or more or even 140 cells or more.

In particular, the larger the electrolyzer is, the more temperature sensors can be incorporated. For instance, one could implement at least one temperature sensor every 60 cells, or every 40 cells, or every 30 cells. Also a thinner mesh can be envisaged, such as to implement at least one temperature sensor every 10 cells or less, even every 8 cells or even every 6 cells. For outmost surveillance, one can also provide to have at least one temperature sensor for each cell. Thereby, failure of one single cell can be properly detected independent of other cells of the electrolyzer.

In a further preferred embodiment, there can be at least one cell having more than one temperature sensor. These could be arranged rather close to each other, such as to give higher redundancy in the surveillance. On the other hand side, they can also be spaced apart, in particular to cover a broader part of the circumferential range the cell, such as to establish a temperature profile ranging from the electrolyte inlet versus the electrolyte outlet.

The sensor can be mounted also in a replaceable manner, in particular by having an insertion-channel in the cell frame accessible from the outside at least after removal of a covering of the insertion channel.

In a further preferred embodiment, it is envisaged that at least one sensor is arranged closer to the endplate opposite to the endplate having electrolyte inlet and/or outlet, this inlet and/or outlet connected to the tubing for circulating the alkali water. For instance, the cathode-side endplate may have inlet and outlet for the electrolyte flow. Further, additionally or alternatively it is preferred to have at least one temperature sensor in the cell having the largest pressure loss of the electrolyte flow through the electrolyzer, respectively in the cell belonging to those cells within the highest 20% of pressure losses among all cells.

In a further preferred embodiment, the measured temperatures is/are compared to a pre-defined criterion and in case of not-fulfillment of the criterion, at least one operation condition of the electrolyzer is changed, the operation state of the electrolyzer is stopped, and/or a future operation duration until the next stop, in particular for maintenance, is determined.

The measuring can be done on regular or selectable repetition. Preferably, said measuring is repeated at least every week, more preferred at least every two days or even at least once a day. Of course, in particular, in order to be able to react also quickly on singular events and/or for have close-mesh surveillance, said determination can be at least once every 8 h, at least once every 4 h, or at least once every 2 h. Of course, also continuous measuring in time or quasi-continuous measuring in time can be performed.

Depending on the observed change in temperature, an operation stop could be provided in case that the temperature goes above a pre-defined threshold corresponding to a serious danger condition such as risk of overheating. A second threshold can be introduced, where passing the threshold gives rise to performed maintenance by issuing a corresponding signal indicating for maintenance to be carried out. Further, a third level threshold could be introduced, the passing thereof being indicative for actions to be taken, possibly also during regular operation of the electrolyzer system, f.i. to increase the volume flow of the electrolyte. Such increase of the volume flow may be counter-controlled by a minimum degassing threshold for the degassing taking place in the electrolyte circulation.

In a preferred embodiment, an evaluation of the measuring and/or monitoring may comprise providing a signal indicative of a recommended remaining operation time, or remaining time until next maintenance, or other actions to be taken during continued operation. Therefore, prognostics can be given, and following the prognostics, a more accurate handling adapted to the actual conditioning of the electrolyzer can be adopted, leading to benefits in operation condition and, therefore, in the long run, to a better long-time performance and/or durability.

In a further, alternative or additional implementation, a measurement can be done from outside the cell stack by one or more thermal cameras.

All the above further monitoring and/or evaluation regarding actions to be taken, maintenance, prognostics apply all the same also for the evaluation of images provided by said one or more thermal cameras. Image recognition software for deriving temperature profiles from said images can be provided. Further, one can derive parameters such as temperature gradients or quantities indicative thereof, in particular with special resolution effective to discern one cell from the other. Evaluation of data and/or comparison of data can be assisted by artificial intelligence.

In a preferred embodiment, the field of view of one camera encompasses, in a projection orthogonal to the staple axis of the electrolyzer, more than 8%, preferably more than 12%, in particular more than 16%, even more than 20% of the cell frame surface. Further, it is preferred that the field of view encompasses the location, where, as seen in some circumferential direction of the electrolyzer, the electrolyte exit from the active area in the cell into the cell frame is provided.

In this context, it is preferred that the staple axis of the electrolyzer is horizontally arranged, and the center line of the field of view in said projection is under an angle α to gravity, a being preferably larger than 10° and/or lower than 90°. This allows the use of a limited number of thermal cameras, also one thermal camera can be sufficient for meaningful surveillance. More preferably, the angle α is lower than 82°, in particular lower than 76°, and/or larger than 20°, in particular larger than 30°.

In terms of devices, the invention provides for an electrolysis arrangement, comprising an electrolyzer having one or more cell stacks within a cell stack, which is essentially characterized by a device for indirect or direct temperature measurement during operation of the electrolzyer in accordance with the method of one or more of the above aspects.

The advantages from said arrangement become apparent from the above discussed advantages of the method.

In this regard, it is preferred that the arrangement comprises at least one sensor having its sensitive element inside the cell stack. Alternatively or additionally, the arrangement may have at least one thermal camera arranged outside the cell stack and having the cell stack at least partially in its field of view.

Further, the invention provides also a frame of a cell of the electrolyzer, having a recess and/or cavity arrangement in the material of the frame to receive a sensitive element and/or wiring of a temperature sensor. It is also envisaged to provide said cell frame already including the sensitive element and/or wiring thereof.

Moreover, the invention provides also a method of forming such a frame part, in particular by casting or injection molding, forming a recess and/or cavity arrangement in the so-formed frame part by a material removing process, in particular a cutting and/or milling process, inserting a sensitive element and its wiring into the so-formed recess and/or cavity arrangement, in particular including a positioning of the wiring prior to the sensitive element and mounting, in particular solding the sensitive element onto the wiring, and closing the recess and/or cavity arrangement, in particular by filling with glue.

Further features, details and advantages of the invention are described in the subsequent with reference to the accompanying figures, in which

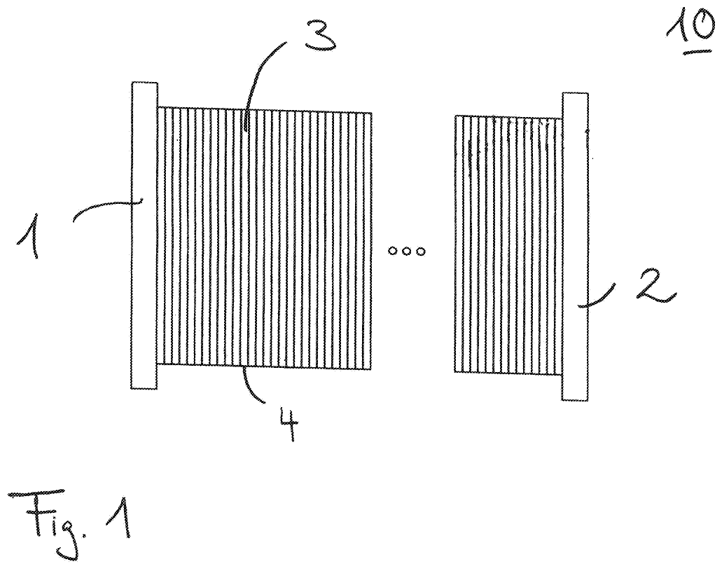

FIG. 1 displays in a simplified manner the rough construction of an electrolyzer of the staple-type,

FIG. 2 is a partial view of a cell frame of an electrolyzer, and

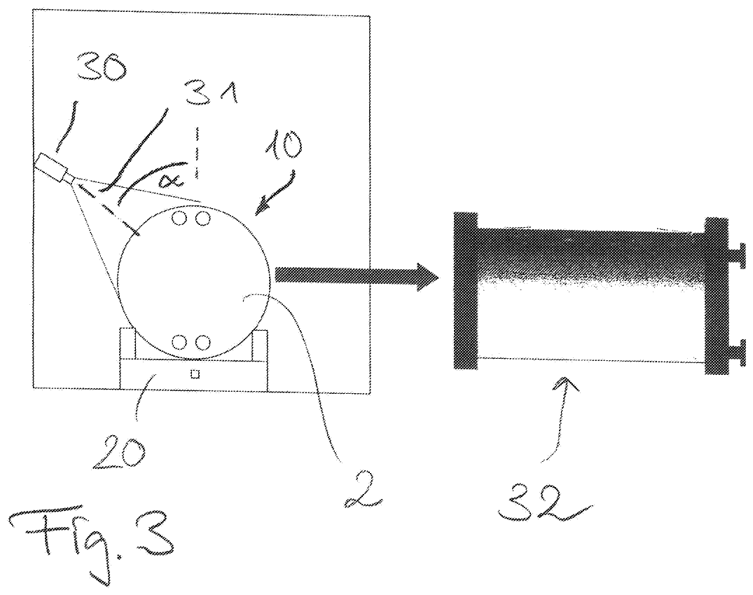

FIG. 3 is an explanatory view of an electrolyzer in the field of view of a camera.

In FIG. 1, a schematical view of an electrolyzer 10 of the staple type is given. Electrolyzer 10 comprises an anode-side endplate 1 and a cathode-side endplate 2, having inbetween a number N of cells 3 with cell frame 4. The number of cells N may be selected in particular among preferred indications given above. The electrolyzer technique used is not particularly limited, f.i. it could be an alkali electrolysis, although connections for tubing is not shown in FIG. 1, and can be implemented in any usual way known to the skilled artisan, as well as the electrical contacts and inclusion of rectifiers, etc., also not shown but readily applied by the skilled artisan.

In FIG. 2, an upper part of a cell frame 4 is shown. The cell frame comprises manifolds for guiding electrolyte through the interior of the cell frames 4 and comprising conduit 5 extending axially through the cell frames 4 of electrolyzer 10, and conduits 6 connecting the interior with the active area of the cell with the axial conduits 5. Also such structure is usual for electrolyzers having electrolyte flowing through the system and is, therefore, no more described in more detail.

In the frame 4, sensitive elements 8a and 8b of temperature sensors are embedded in corresponding recesses formed in the frame. By being embedded in the frame material, as shown in FIG. 2, in close proximity to the border to the interior and to conduits 5, 6, but not in fluid communication thereto, the sensitive elements 8a and 8b are protected from chemical attacks of the electrolyte. These sensitive elements could be resistors on platin basis, as PT100 or PT1000 elements. The wiring thereof is indicated in FIG. 2 with reference numerals 9a and 9b, and could be implemented by a 2-wiring, a 3-wiring, or a 4-wiring, in accordance with the desired accuracy of measurement and in particular the selected length of the wiring 9.

To obtain such modified frame, that is a frame capable of temperature sensoring, the frame body can be, in a first step, formed in a conventional manner, f.i. by casting or injection molding. Thereafter, a recess can be formed in the frame, together with channels for the wiring 9. Then, the wiring could be inserted into the channels and, in the present exemplary embodiment, the PT1000 is sold to the wiring in its received position. Then, the recesses and channels can be closed, f.i. by filling with glue. The material parameters of the glue can be selected to be at least in the same order of magnitude of that of the frame material. Thereafter, the surfaces are flattened to re-establish the original flat surfaces of the frame.

By said temperature measuring arrangement, the temperature and changes in the temperature can be measured at the location of the sensitive elements 8a, 8b. In particular, said temperature can be measured during the regular operation of the electrolyzer, which is in particular the electrolysis of water to produce hydrogen (and oxygen).

The temperature can also be monitored, in particular continuously, and in particular within the aspects explained above. Monitoring and surveillance of the temperature and its changes can be used for proper scheduling of maintenance, f.i., such that timely maintenance can be scheduled within a security window to safeguard proper functionality of the electrolyzer, and can be also selected close to the required maintenance and not too much time before, in order to keep the performance high and not affected by any too early or too frequently performed maintenance.

In FIG. 3, another embodiment of the invention is shown in an explanatory view. Therein, electrolyzer 10 is shown in a side-view (direction of staple axis orthogonal to the paper plane), such that one sees cathode-side endplate 2 of electrolyzer 10 mounted on holder 20. The electrolyzer 10 is in the field of view 31 of a thermal camera 30. Thermal camera 30 takes an image (exemplified by 32), said image 32 showing a heat distribution and being, therefore, indicative for a temperature profile within the electrolyzer 10. It is to note that the distribution as shown in FIG. 3 is exaggerated and is meant to indicate the existence of a temperature profile and not a uniform heat distribution all over the electrolyzer.

By analysis of those images 32 taken in regular or non-regular intervals by thermal camera 30, and observation of the changes in the temperature profile, in particular in comparison with those temperature profiles established for properly working electrolyzers, again a monitoring and surveillance similar to that of the first embodiment can be provided, only with indirect measurement, and maintenance can be scheduled in an optimized manner.

Moreover, by having the surveillance continuous or effectively continuous, f.i. within the time frames described in more detail above, also failures and/or hazards in the electrolyzer system can be recognized early and respective measures can be taken as emergency stop or controlled shutdown of the electrolyzer.

The invention is not limited to the embodiments shown above in more detail and rather, features of the previous description as well as of the subsequent claims can be, alone or in combination, essential for the invention in its various aspects.

1-17. (canceled)

18. A method for operating an electrolyzer comprising at least one cell stacked within a cell stack, comprising the step of indirectly or directly measuring, during operation of the electrolyzer, temperature in at least one location in the cell stack.

19. The method according to claim 18, including directly measuring the temperature by at least one sensor having a sensitive element inserted inside the cell stack.

20. The method according to claim 19, including inserting the sensitive element in a cell frame in close proximity to a border to an interior of the cell frame and/or to a channel connecting said interior to an axially extending collecting channel in the frame.

21. The method according to claim 18, wherein the measuring is based on resistance temperature devices (RTD).

22. The method according to claim 21, including guiding a wiring of the RTD to outside of an outer shell of the cell frame.

23. The method according to claim 18, wherein there is at least one sensitive element for each n cells, n being N or lower, N being a total number of cells in the stack.

24. The method according to claim 19, wherein the at least one sensor is arranged closer to an endplate opposite to an endplate having electrolyte inlet and/or outlet.

25. The method according to claim 18, including comparing the measured temperature to a pre-defined criterion and, in case of non-fulfillment of the criterion, changing at least one operation condition of the electrolyzer, stopping the operation state of the electrolyzer, and/or determining a future operation duration until a next stop.

26. The method according to claim 18, including measuring the temperature from outside the cell stack using at least one thermal camera.

27. The method according to claim 26, wherein the camera has a field of view that encompasses, in a projection orthogonal to a staple axis of the electrolyzer, more than 8% of a cell frame surface.

28. The method according to claim 27, wherein field of view of the camera encompasses more than 12% of the cell frame surface.

29. The method according to claim 28, wherein field of view of the camera encompasses more than 16% of the cell frame surface.

30. The method according to claim 29, wherein field of view of the camera encompasses more than 20% of the cell frame surface.

31. The method according to claim 27, wherein the staple axis is substantially horizontal, and a center line of the field of view in said projection is under an angle α to gravity, a being larger than 10° and/or lower than 90°.

32. The method according to claim 27, including analyzing data/images provided by the camera based on a spatial resolution allowing allocation of a temperature inhomogeneity in the data to one cell of the cell stack.

33. An electrolysis arrangement, comprising: an electrolyzer having at least one cell stacked within a cell stack; and a device configured for indirect or direct temperature measurement during operation of the electrolyzer in accordance with the method according to claim 18.

34. The arrangement according to claim 33, further comprising at least one sensor having a sensitive element inside the cell stack.

35. The arrangement according to claim 33, further comprising at least one thermal camera arranged outside the cell stack so that the cell stack is at least partially in a field of view of the camera.

36. A part of an arrangement according to claim 29, the part being configured as a frame of a cell of the electrolyzer, the frame having a recess and/or cavity arrangement in a material of the frame configured to receive a sensitive element and/or wiring of a temperature sensor.

37. The part according to claim 36, wherein the sensitive element and/or wiring thereof is arranged in the recess and/or cavity arrangement.

38. The method of forming a part in accordance with claim 37, comprising the steps of: forming a frame part; forming a recess and/or cavity arrangement in the frame part by a material removing process; inserting a sensitive element and wiring of the sensitive element into the recess and/or cavity arrangement; and closing the recess and/or cavity arrangement.

39. The method according to claim 38, wherein the step of inserting the sensitive element includes first positioning the wiring into the recess and then mounting the sensitive element onto the wiring.
